(19) United States
(12) Patent Application Publication
(10) Pub. No.: US 2007/0075198 A1
(43) Pub. Date: Apr. 5, 2007

(54) Holding element for grating

(75) Inventor: Thomas Foser, Balzers (LI)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/519,329

(22) Filed: Sep. 11, 2006

(30) Foreign Application Priority Data
Sep. 21, 2005 (DE) 10 2005 000 121.1

(51) Int. Cl. F21V 21/00

(52) U.S. Cl. 248/226.11

(57) ABSTRACT

A U-shaped holding element for securing gratings (50) on supports (40) has a connection web (13), a first leg (11) projecting from the connection web (13) and having an opening (15) for passing a threaded fastener (30) therethrough, and a second leg (12) projecting from the connection web (13) and having a counter-thread (24) for a thread (31) of the threaded fastener (30), and a retaining element (26) facing the first leg (11) for securing the holding element (10) on a support (40).

### BACKGROUND OF THE INVENTION

1. Field of the Invention

The present invention relates to a U-shaped holding element for securing a grating on a support and having first and second legs projecting form a connection web.

2. Description of the Prior Art

U.S. Pat. No. 5,118,147 discloses a holding element for a grating in which a hook-shaped first end engages a support, and on its second end remote from the hook-shaped first end, an engagement location for a screw is provided. The screw connects the holding element with a plate-shaped element abutting the grating and which, upon tightening, is secured to the support.

The drawback of the holding element of U.S. Pat. No. 5,118,147 consists in that it cannot be used without the plate-shaped element as a counter-support.

European Publication EP 0 923 675 B1 discloses a U-shaped hold-down element for a metal grating and which has two opposite legs that project from a connection web. The end of the second leg remote from the connection web is inclined in a direction away from the first leg, whereas the end of the first leg remote from the connection web is inclined toward the second leg. In order to provide a fulcrum during mounting of the hold-down element, a projection adjacent to the second leg is arranged in the proximity of the bent end of the first leg. The projection engages, during mounting of the hold-down element, an edge of a cross-strip of the cell of the metal grating.

The drawback of the disclosed hold-down element consists in that it can be easily separated from the grating, so that the grating can still be easily manipulated from the opposite side and, occasionally, can be separated form the support or the constructional element.

The object of the present invention is to provide a holding element in which the foregoing drawbacks are eliminated.

Another object of the present invention is to provide a holding element that can be easily mounted.

A further object of the present invention is to provide a holding element with good holding values.

### SUMMARY OF THE INVENTION

These and other objects of the present invention, which will become apparent hereinafter are achieved by providing a U-shaped holding element having a first leg projecting from the connection web and having an opening for passing a threaded fastener therethrough, and a second leg projecting from the connection web and having a counter-thread for a thread of the threaded fastener and retaining means facing the first leg for securing the holding element on a support.

With the inventive holding element, a grating can be reliably and simply secured with a threaded fastener on a support, with the retaining means digging into the support. The holding element is formed as a one-piece part, and additional parts such as, e.g., plate-shaped element is not any more necessary.

It is advantageous when the second leg forms a short lever arm extending between the counter-thread and the flector that forms a transition to the connection web, and a long arm extending between the flector and the retaining means.

Advantageous balanced transmission ratios are achieved when the long lever arm is by 1.5 to 5 times longer than the short lever arm.

It is advantageous when the opening in the first leg is formed in a recess. Thereby, the fastener head can be sunk relative to the surface of the grating. It is further advantageous when the opening is formed as an elongate opening, so that the fastener can be positioned with a large clearance.

Advantageously, the first leg is formed longer than the second leg, projecting past the end of the second leg. Thereby, the holding element automatically tensions the support and the grating relative to each other, digging thereinto without sliding or side-slipping therefrom.

It is further advantageous when the first leg has, in its region remote from the connection web, a sidewise projecting flat section. The flat section provides for abutment or for support of the first leg over at least one longitudinal strip of the grating. This noticeably increases the quality of the attachment of the grating.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS:

The drawings show:

FIG. 1 a perspective view of a holding element according to the present invention for a grating;

FIG. 2 a plan view of the holding element in a condition in which the holding element is secured on the grating and a support; and

FIG. 3 a side cross-sectional view along line III-III in FIG. 2 of the holding element secured on the grating and the support.

### DETAILED DESCRIPTION OF THE PREFERRED EMBODIMENTS

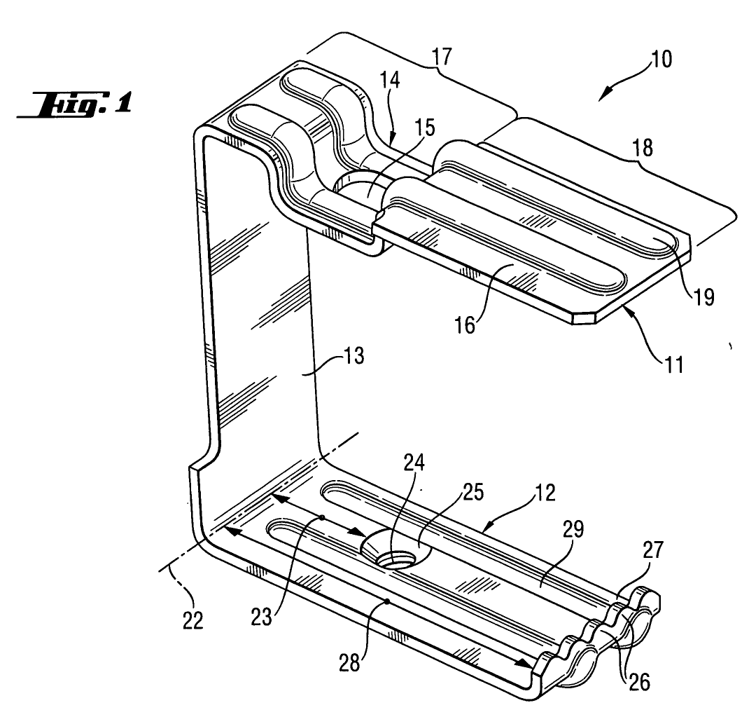

FIGS. 1-3 show an embodiment of a holding element 10 according to the present invention for attaching a grating 50 or a grid to a support 40 of a lower structure. The holding element 10 is formed as a U-shaped element and has a first leg 11 and a second leg 12 which project in the same direction from a connection web 13. The transition from the connection web 13 to the second leg 12 functions as a flector 22. The first leg 11 has, in its first region 17 adjacent to the connection web 13, a recess 14 with an opening 15 for a fastener 30.

The first leg 11 further has, in its second region 18 remote from the connection web 13, a flat section 16 projecting sidewise.

The second leg 12 has a hole 25 which is located opposite the opening 15 in the first leg 11 and has a matching thread 24 in which the fastener 30 engages with its thread 31. The second leg 12 has, in its end region 27 remote from the connection web 13, retaining means 26 that is formed as teeth and that faces the first leg 11.

The first leg 11 is bigger than the second leg 12 and is longer than the connection web 13.

Upon mounting of the holding element 10, firstly, it is pushed through with its second leg 12 and the connection leg 12 and the connection web 13 between two cross-struts 51 of the grating 50 (not shown in the Figs.) so that the end region 27 of the second leg 12 is positioned with its retaining means 26 under the support 40. Finally, the fastener 30 is inserted in the opening 15 and is screwed with its thread 31 into the thread 24 in the hole 25. Because of a lever transmission on the second leg 12 of about 1.5/1 to 5/1 between a long lever arm 28 extending from the flector 22 up to retaining means 26, and a short lever arm 23 extending between the connection web 13 and the hole 25, the end of the long lever arm 28 would displace, upon tightening of the fastener 30, more rapidly, i.e., with an increased tension path, in the direction of the first leg 11 than the region carrying the thread 24. Thereby, the retaining means 26 can be already brought in a forcelocking abutment with the support 40 by a small number of revolutions of the fastener 30.

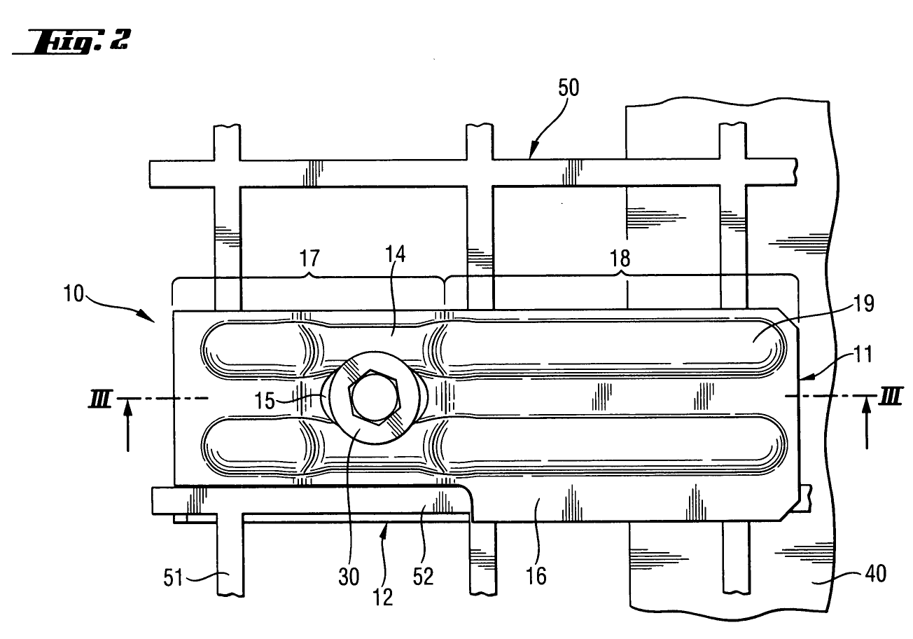

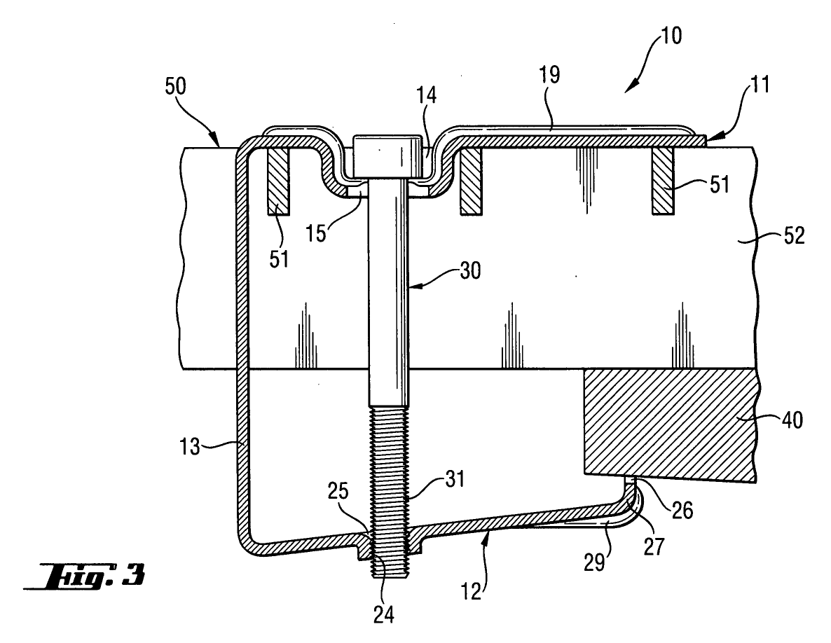

As shown in FIGS. 2 and 3, the first leg 1 lies, in a mounted condition, on the cross-struts 51 of the grating 50, extending substantially perpendicular thereto. The flat section 16, because it projects sidewise from the second region 18 of the first leg 11, lies on an elongate strut 52 of the grating 50. The second leg 12 engages, as it has already been discussed above, with the retaining means 26, which is provided in the end region 28, the bottom of the support 40, digging its teeth thereinto.

In order to reinforce the holding element 10, reinforcement elements 19, 29, which are formed e.g., as beads are provided on the first leg 11 and the second leg 12.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A U-shaped holding element for securing gratings (50) on supports (40), comprising a connection web (13); a first leg (11) projecting from the connection web (13) and having an opening (15) for passing a threaded fastener (30) therethrough; and a second leg (12) projecting from the connection web (13) and having a counter-thread (24) for a thread (31) of the threaded fastener (30), and retaining means (26) facing the first leg (11) for securing the holding element (10) on a support (40).

2. A holding element according to claim 1, wherein the second leg (12) forms a short lever arm (23) extending between the counter-thread (24) and flector (22) that forms a transition to the connection web (13), and a long arm (28) extending between the flector (22) and the retaining means (26).

3. A holding element according to claim 2, wherein the long arm (28) is longer than the short arm (23) by from 1.5 to 5 times.

4. A holding element according to claim 1, wherein the opening (15) is formed in a recess (14) provided in the first leg (11).

5. A holding element according to claim 1, wherein the first leg (11) is longer than the second leg (12).

6. A holding element according to claim 1, wherein the first leg (11) has, in a region (18) thereof remote from the connection web (13), a sidewise projecting flat section (16).
